(19) United States
(12) Patent Application Publication
(10) Pub. No.: US 2011/0157546 A1
(43) Pub. Date: Jun. 30, 2011

(54) OPHTHALMIC SYSTEM COMBINING OPHTHALMIC COMPONENTS WITH BLUE LIGHT WAVELENGTH BLOCKING AND COLOR-BALANCING FUNCTIONALITIES

(75) Inventors: Andrew Ishak, Havre de Grace, MD (US); Joshua N. Haddock, Roanoke, VA (US); William Kokonaski, Gig Harbor, WA (US); Dwight Duston, Laguna Niguel, CA (US); Venkatramani S. Iyer, Roanoke, VA (US); Ronald D. Blum, Roanoke, VA (US)

(73) Assignee: High Performance Optics, Inc., Roanoke, VA (US)

(21) Appl. No.: 13/014,483

(22) Filed: Jan. 26, 2011

Related U.S. Application Data
(62) Division of application No. 11/378,317, filed on Mar. 20, 2006, now abandoned.

(51) Int. Cl. G02C 7/10

(52) U.S. Cl. 351/163

(57) ABSTRACT

Embodiments of the present invention relate to an ophthalmic system that performs effective blue blocking for an ophthalmic lens while at the same time providing a cosmetically attractive product, normal or acceptable color perception for a user, and a high level of transmitted light for good visual acuity.

### BACKGROUND OF THE INVENTION

The present invention relates to an ophthalmic system. More particularly, the invention relates to an ophthalmic system that performs blocking of blue light wavelengths (hereafter, “blue blocking”) in ophthalmic lenses, while presenting a cosmetically attractive product. “Ophthalmic system” as used here includes prescription or non-prescription ophthalmic lenses used, e.g., for glasses (or spectacles), sunglasses, contact lenses, intra-ocular lenses or corneal inlays, and treated or processed or combined with other components to provide desired functionalities described in further detail in the following.

Current research strongly supports the premise that short wavelength visible light (blue light) having a wavelength of approximately 400 nm-500 nm (nanometers or 10.sup.-9 meters) could be a contributing cause of AMD (age related macular degeneration). It is believed that the highest level of blue light absorption occurs at or near 450 nm. Research further suggests that blue light worsens other causative factors in AMD, such as heredity, tobacco smoke, and excessive alcohol consumption.

Light is made up of electromagnetic radiation that travels in waves. The electromagnetic spectrum includes radio waves, millimeter waves, microwaves, infrared, visible light, ultra-violet (UVA and UVB) and x-rays and gamma rays. The human retina responds only to the visible light portion of the electromagnetic spectrum. The visible light spectrum includes the longest visible light wavelength spectrum. The visible light spectrum includes the longest visible light wavelength of approximately 700 nm and the shortest of approximately 400 nm. Blue light wavelengths fall in the approximate range of 400 nm to 500 nm. For the ultra-violet bands, UVB wavelengths are from 290 nm to 320 nm and UVA wavelengths are from 320 nm to 400 nm.

The human retina includes multiple layers. These layers listed in order from the first exposed to any light entering the eye to the deepest include:

1) Nerve Fiber Layer

2) Ganglion Cells

3) Inner Plexiform Layer

4) Bipolar and Horizontal Cells

5) Outer Plexiform Layer

6) Photoreceptors (Rods and Cones)

7) Retinal Pigment Epithelium (RPE)

8) Bruch's Membrane

9) Choroid

When light is absorbed by the eye's photoreceptor cells, (rods and cones) the cells bleach and become unreceptive until they recover. This recovery process is a metabolic process and is called the “visual cycle.” Absorption of blue light has been shown to reverse this process prematurely. This premature reversal increases the risk of oxidative damage and is believed to lead to the buildup of the pigment lipofuscin in the retina. This build up occurs in the retinal pigment epithelium (RPE) layer. It is believed that aggregates of extra-cellular materials called drusen are formed in the RPE layer due to the excessive amounts of lipofuscin. Drusen hinder or block the RPE layer from providing the proper nutrients to the photoreceptors, which leads to damage or even death of these cells. To further complicate this process it appears that when lipofuscin absorbs blue light in high quantities it becomes toxic, causing further damage and/or death of the RPE cells.

The lighting and vision care industries have standards as to human vision exposure to UVA and UVB radiation Surprisingly, no such standard is in place with regard to blue light. For example, in the common fluorescent tubes available today, the glass envelope mostly blocks ultra-violet light but blue light is transmitted with little attenuation. In some cases, the envelope is designed to have enhanced transmission in the blue region of the spectrum.

Ophthalmic systems that provide blue blocking to some degree are known. However, there are disadvantages associated with such systems. For example, they tend to be cosmetically unappealing because of a yellow or amber tint that is produced in lenses by blue blocking More specifically, one common technique for blue blocking involves tinting or dyeing lenses with a blue blocking tint, such as BPI Filter Vision 450 or BPI Diamond Dye 500. The tinting may be accomplished, for example, by immersing the lens in a heated tint pot containing a blue blocking dye solution for some predetermined period of time. Typically, the dye solution has a yellow or amber color and thus imparts a yellow or amber tint to the lens. To many people, the appearance of this yellow or amber tint may be undesirable cosmetically. Moreover, the tint may interfere with the normal color perception of a lens user, making it difficult, for example, to correctly perceive the color of a traffic light or sign.

Efforts have been made to compensate for the yellowing effect of blue blocking For example, blue blocking lenses have been treated with additional dyes, such as blue, red or green dyes, to offset the yellowing effect. The treatment causes the additional dyes to become intermixed with the original blue blocking dyes. However, while this technique may reduce yellow in a blue blocked lens, it also reduces the effectiveness of the blue blocking by allowing more of the blue light spectrum through. Moreover, the technique may reduce the overall transmission of light wavelengths other than blue light wavelengths. This unwanted reduction may in turn result in reduced visual acuity for a lens user.

In view of the foregoing, there is a pressing need for an ophthalmic lens that will perform blue blocking with an acceptable level of blue light protection, while providing for acceptable color cosmetics, acceptable color perception for a user, and an acceptable level of light transmission for wavelengths other than blue light wavelengths.

### BRIEF DESCRIPTION OF THE DRAWINGS

FIGS. 1A and 1B show examples of an ophthalmic system including a posterior blue blocking component and an anterior color balancing component according to embodiments of the present invention;

FIG. 2 shows an example of using a dye resist to form an embodiment of the present invention;

FIG. 3 illustrates an embodiment of the present invention wherein a blue blocking component and a color balancing component are integrated into a clear or mostly clear ophthalmic lens;

FIG. 4 illustrates forming an embodiment of the present invention using an in-mold coating;

FIG. 5 illustrates bonding two ophthalmic components to form an embodiment of the present invention;

FIG. 6 illustrates embodiments of the present invention including anti-reflective coatings;

FIGS. 7A-7C illustrate various combinations of a blue blocking component, a color balancing component, and an ophthalmic component according to embodiments of the present invention; and

FIGS. 8A and 8B show examples of an ophthalmic system including a multi-functional blue blocking and color-balancing component according to embodiments of the present invention.

### DETAILED DESCRIPTION OF THE INVENTION

Embodiments of the present invention relate to an ophthalmic system that performs effective blue blocking while at the same time providing a cosmetically attractive product, normal or acceptable color perception for a user, and a high level of transmitted light for good visual acuity.

More specifically, embodiments of the invention may provide effective blue blocking in combination with color balancing. “Color balancing” or “color balanced” as used herein means that the yellow or amber color, or other unwanted effect of blue blocking is reduced, offset, neutralized or otherwise compensated for so as to produce a cosmetically acceptable result, without at the same time reducing the effectiveness of the blue blocking. For example, wavelengths at or near 450 nm may be blocked or reduced in intensity. In particular, for example, wavelengths between about 440 nm to about 460 nm may be blocked or reduced in intensity. Furthermore, transmission of unblocked wavelengths may remain at a high level, for example at least 85%. Additionally, to an external viewer, the ophthalmic system may look clear or mostly clear. For a system user, color perception may be normal or acceptable.

An ophthalmic system according to embodiments of the present invention may comprise a blue blocking component posterior to a color-balancing component. Either of the blue blocking component or the color balancing component may be, or form part of, an ophthalmic component such as a lens. In other embodiments, the posterior blue blocking component and anterior color balancing component may be distinct layers on or adjacent to or near a surface or surfaces of an ophthalmic lens. Because the blue blocking component is posterior to the color balancing component, it will always be oriented with respect to a user so that incident light first strikes the color balancing component, before passing through the blue blocking component to be received by the user's eyes. The color-balancing component may reduce or neutralize a yellow or amber tint of the posterior blue blocking component, to produce a cosmetically acceptable appearance. For example, to an external viewer, the ophthalmic system may look clear or mostly clear. For a system user, color perception may be normal or acceptable. Further, because the blue blocking and color balancing tints are not intermixed, wavelengths in the blue light spectrum may be blocked or reduced in intensity and the transmitted intensity of incident light in the ophthalmic system may be at least 85% for unblocked wavelengths.

As discussed previously, techniques for blue blocking are known. The known techniques to block blue light wavelengths include absorption, reflection, interference, or any combination thereof. As discussed earlier, according to one technique, a lens may be tinted/dyed with a blue blocking tint, such as BPI Filter Vision 450 or BPI Diamond Dye 500, in a suitable proportion or concentration. The tinting may be accomplished, for example, by immersing the lens in a heated tint pot containing a blue blocking dye solution for some predetermined period of time. According to another technique, a filter is used for blue blocking The filter could include, for example, organic or inorganic compounds exhibiting absorption and/or reflection of and/or interference with blue light wavelengths. The filter could comprise multiple thin layers or coatings of organic and/or inorganic substances. Each layer may have properties, which, either individually or in combination with other layers, absorbs, reflects or interferes with light having blue light wavelengths. Rugate notch filters are one example of blue blocking filters. Rugate filters are single thin films of inorganic dielectrics in which the refractive index oscillates continuously between high and low values. Fabricated by the co-deposition of two materials of different refractive index (e.g. SiO.sub.2 and TiO.sub.2), rugate filters are known to have very well defined stop-bands for wavelength blocking, with very little attenuation outside the band. The construction parameters of the filter (oscillation period, refractive index modulation, number of refractive index oscillations) determine the performance parameters of the filter (center of the stop-band, width of the stop band, transmission within the band). Rugate filters are disclosed in more detail in, for example, U.S. Pat. No. 6,984,038, which is fully incorporated herein by reference. Another technique for blue blocking is the use of multi-layer dielectric stacks. Multi-layer dielectric stacks are fabricated by depositing discrete layers of alternating high and low refractive index materials. Similarly to rugate filters, design parameters such as individual layer thickness, individual layer refractive index, and number of layer repetitions determine the performance parameters for multi-layer dielectric stacks.

Color balancing according to embodiments of the invention may comprise imparting, for example, a suitable proportion or concentration of blue tinting/dye, or a suitable combination of red and green tinting/dyes to the color-balancing component, such that when viewed by an external observer, the ophthalmic system as a whole has a cosmetically acceptable appearance. For example, the ophthalmic system as a whole may look clear or mostly clear.

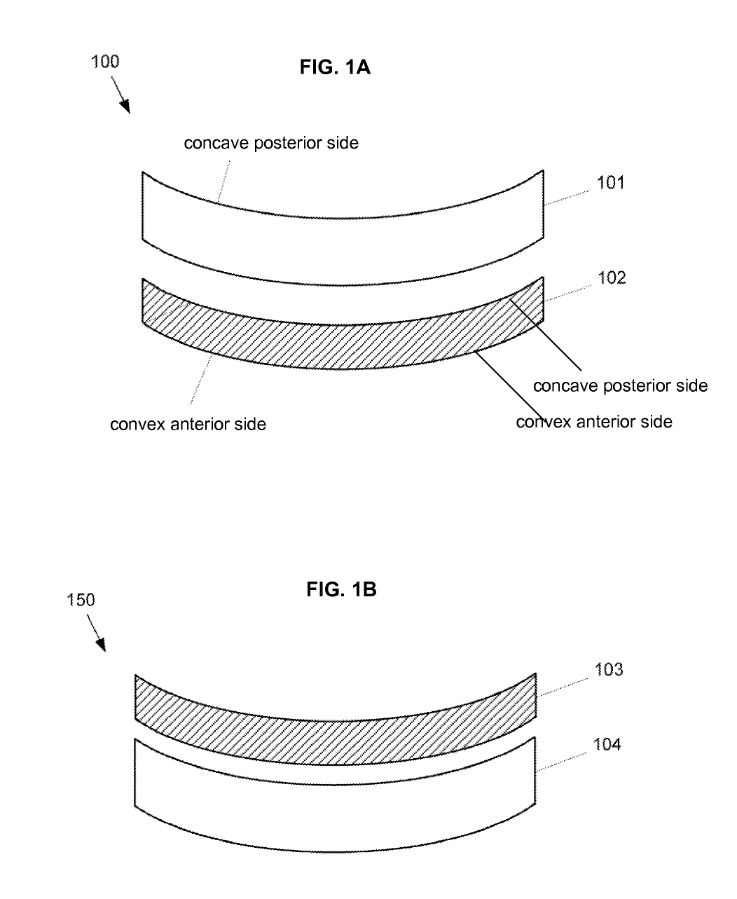

FIG. 1A shows one possible embodiment of an ophthalmic system according to the present invention. The system 100 may include a posterior blue blocking component 101 and an anterior color-balancing component 102. In system 100, the posterior blue blocking component 101 may be or include an ophthalmic component, such as a single vision lens, wafer or optical pre-form. The single vision lens, wafer or optical pre-form may be tinted or dyed to perform blue blocking The anterior color-balancing component 102 may comprise a surface cast layer, applied to the single vision lens, wafer or optical pre-form according to known techniques. For example, the surface cast layer may be affixed or bonded to the single vision lens, wafer or optical pre-form using visible or UV light, or a combination of the two.

The surface cast layer may be formed on the convex side of the single vision lens, wafer or optical pre-form. Since the single vision lens, wafer or optical pre-form has been tinted or dyed to perform blue blocking, it may have a yellow or amber color that is undesirable cosmetically. Accordingly, the surface cast layer may, for example, be tinted with a suitable proportion of blue tinting/dye, or a suitable combination of red and green tinting/dyes.

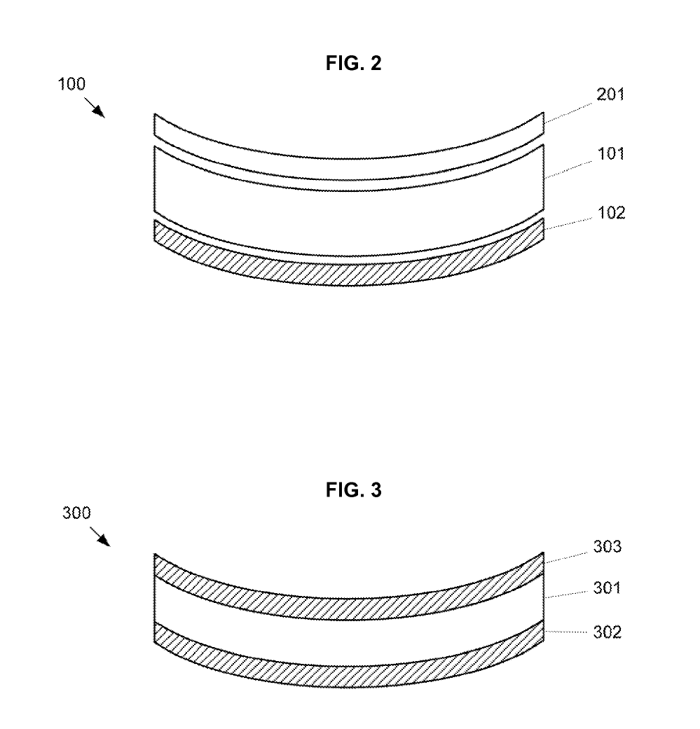

The surface cast layer may be treated with color balancing additives after it is applied to the single vision lens, wafer or optical pre-form that has already been processed to make it blue blocking. For example, the blue blocking single vision lens, wafer or optical pre-form with the surface cast layer on its convex surface may be immersed in a heated tint pot which has the appropriate proportions and concentrations of color balancing dyes in a solution. The surface cast layer will take up the color balancing dyes from the solution. To prevent the blue blocking single vision lens, wafer or optical pre-form from absorbing any of the color balancing dyes, its concave surface may be masked or sealed off with a dye resist, e.g. tape or wax or other coating. This is illustrated in FIG. 2, which shows ophthalmic system 100 with a dye resist 201 on the concave surface of the single vision lens, wafer or optical pre-form 101. The edges of the single vision lens, wafer or optical pre-form may be left uncoated to allow them to become cosmetically color adjusted. This may be important for negative focal lenses having thick edges.

FIG. 1B shows another possible embodiment of an ophthalmic system according to the present invention. In system 150, the anterior color-balancing component 104 may be or include an ophthalmic component, such as a single vision or multi-focal lens, wafer or optical pre-form. The posterior blue blocking component 103 may be a surface cast layer. To make this combination, the convex surface of the color balancing single vision lens, wafer or optical pre-form may be masked with a dye resist as described above, to prevent it taking up blue blocking dyes when the combination is immersed in a heated tint pot containing a blue blocking dye solution. Meanwhile, the exposed surface cast layer will take up the blue blocking dyes.

It should be understood that the surface cast layer could be used in combination with a multi-focal, rather than a single vision, lens, wafer or optical pre-form. In addition, the surface cast layer could be used to add power to a single vision lens, wafer or optical pre-form, including multi-focal power, thus converting the single vision lens, wafer or optical pre-form to a multi-focal lens, with either a lined or progressive type addition. Of course, the surface cast layer could also be designed to add little or no power to the single vision lens, wafer or optical pre-form.

FIG. 3 shows another embodiment according to the present invention. In FIG. 3, blue blocking and color balancing functionality are integrated into an ophthalmic component. More specifically, in ophthalmic lens 300, a portion 303, corresponding to a depth of tint penetration into an otherwise clear or mostly clear ophthalmic component 301 at a posterior region thereof may be blue blocking. Further, a portion 302, corresponding to a depth of tint penetration into the otherwise clear or mostly clear ophthalmic component 301 at a frontal or anterior region thereof may be color balancing. The embodiment of FIG. 3 may be produced as follows. The ophthalmic component 301 may, for example, initially be a clear or mostly clear single vision or multi-focal lens, wafer or optical pre-form. The clear or mostly clear single vision or multi-focal lens, wafer or optical pre-form may be tinted with a blue blocking tint while its front convex surface is rendered non-absorptive, e.g., by masking or coating with a dye resist as described previously. As a result, a portion 303, beginning at the posterior concave surface of the clear or mostly clear single vision or multi-focal lens, wafer or optical pre-form 301 and extending inwardly, and having blue blocking functionality, may be created by tint penetration. Then, the anti-absorbing coating of the front convex surface may be removed. An anti-absorbing coating may then be applied to the concave surface, and the front convex surface and peripheral edges of the single vision or multi-focal lens, wafer or optical pre-form may be tinted (e.g. by immersion in a heated tint pot) for color balancing. The color balancing dyes will be absorbed by the peripheral edges and a portion 302 beginning at the front convex surface and extending inwardly, that was left untinted due to the earlier coating. The order of the foregoing process could be reversed: i.e., the concave surface could first be masked while the remaining portion was tinted for color balancing. Then, the coating could be removed and a depth or thickness at the concave region left untinted by the masking could be tinted for blue blocking.

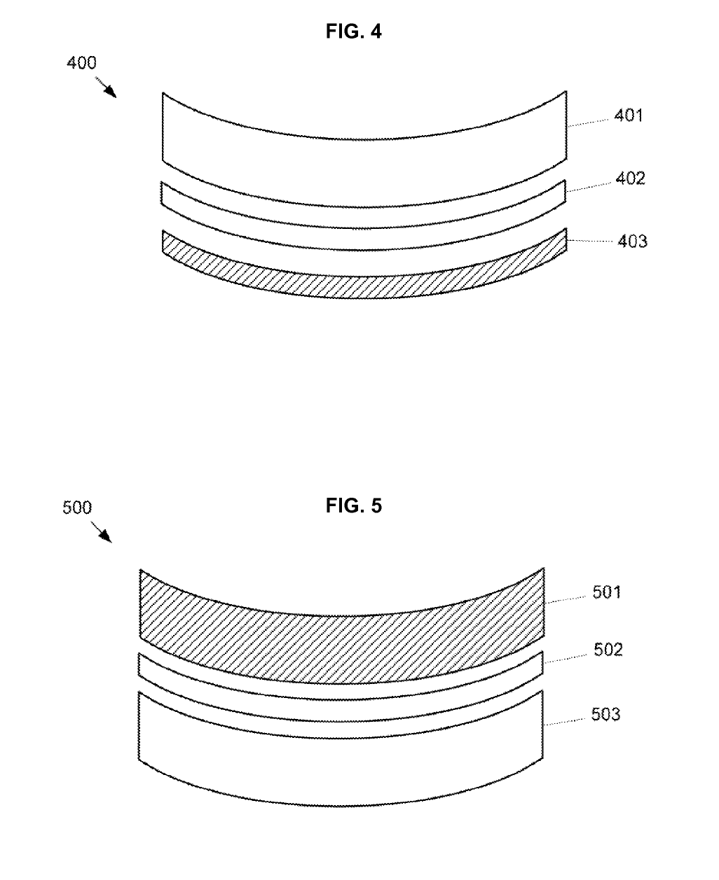

Referring now to FIG. 4, in other embodiments of the present invention, an ophthalmic system 400 may be formed using an in-mold coating. More specifically, an ophthalmic component 401 such as a single vision or multi-focal lens, wafer or optical pre-form which has been dyed/tinted with a suitable blue blocking tint, dye or other additive may be color balanced via surface casting using a tinted in-mold coating 403. The in-mold coating 403, comprising a suitable level and/or mixtures of color balancing dyes, may be applied to the convex surface mold (i.e., a mold, not shown, for applying the coating 403 to the convex surface of the ophthalmic component 401). A colorless monomer 402 may be filled in and cured between the coating 403 and ophthalmic component 401. The process of curing the monomer 402 will cause the color balancing in-mold coating to transfer itself to the convex surface of the ophthalmic component 401. The result is a blue blocking ophthalmic system with a color balancing surface coating. The in-mold coating could be, for example, an anti-reflective coating or a conventional hard coating.

Referring now to FIG. 5, in still other embodiments of the present invention, an ophthalmic system 500 may comprise two ophthalmic components, one blue blocking and the other color balancing. For example, a first ophthalmic component 501 could be a back single vision or concave surface multi-focal lens, wafer or optical pre-form, dyed/tinted with the appropriate blue blocking tint to achieve the desired level of blue blocking. A second ophthalmic component 503 could be a front single vision or convex surface multi-focal lens, wafer or optical pre-form, bonded or affixed to the back single vision or concave surface multi-focal lens, wafer or optical pre-form, for example using a UV or visible curable adhesive 502. The front single vision or convex surface multi-focal lens, wafer or optical pre-form could be rendered color balancing either before or after it was bonded with the back single vision or concave surface multi-focal lens, wafer or optical pre-form. If after, the front single vision or convex surface multi-focal lens, wafer or optical pre-form could be rendered color balancing, for example, by techniques described above. For example, the back single vision or concave surface multi-focal lens, wafer or optical pre-form may be masked or coated with a dye resist to prevent it taking up color balancing dyes. Then, the bonded back and front portions may be together placed in a heated tint pot containing a suitable solution of color balancing dyes, allowing the front portion to take up color balancing dyes.

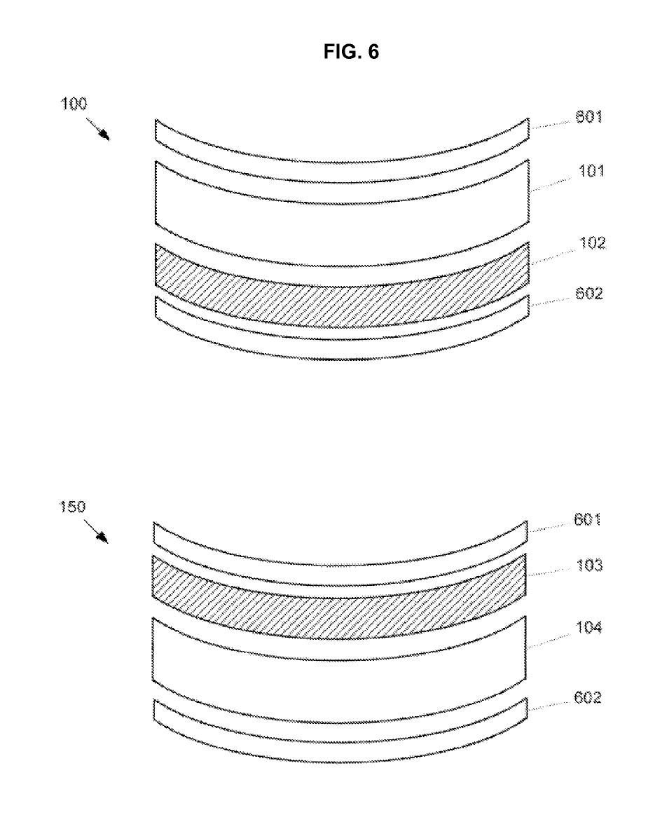

Any of the above-described embodiments of the present invention, or embodiments not explicitly disclosed herein, may be combined with one or more anti-reflective (AR) components. This is shown in FIG. 6, by way of example, for the ophthalmic lenses 100 and 150 shown in FIGS. 1A and 1B. In FIG. 6, a first AR component 601, e.g. a coating, is applied to the concave surface of posterior blue blocking element 101, and a second AR component 602 is applied to the convex surface of color balancing component 102. Similarly, a first AR component 601 is applied to the concave surface of posterior blue blocking component 103, and a second AR component 602 is applied to the convex surface of color balancing component 104.

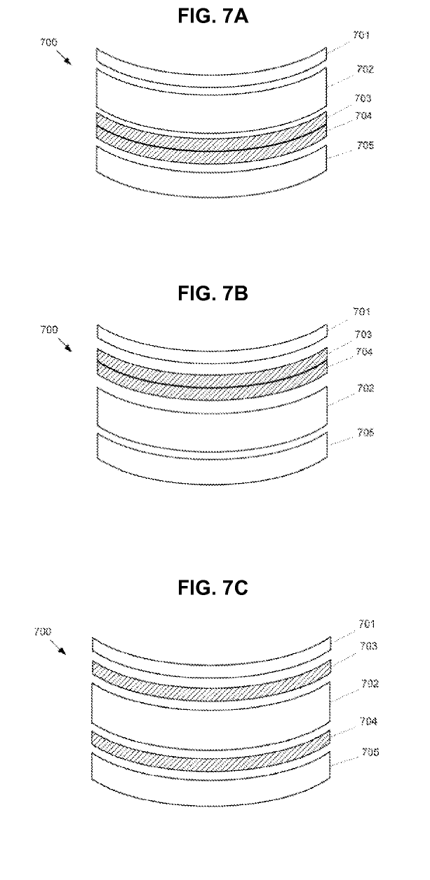

Further embodiments of the present invention are illustrated in FIGS. 7A-7C. In FIG. 7A, an ophthalmic system 700 includes a blue blocking component 703 and a color balancing component 704 that are formed as adjacent, but distinct, coatings or layers on or adjacent to the anterior surface of a clear or mostly clear ophthalmic lens 702. The blue blocking component 703 is posterior to the color-balancing component 704. On or adjacent to the posterior surface of the clear or mostly clear ophthalmic lens, an AR coating or layer 701 may be formed. Another AR coating or layer 705 may be formed on or adjacent to the anterior surface of the color-balancing layer 704.

In FIG. 7B, the blue blocking component 703 and color-balancing component 704 are arranged on or adjacent to the posterior surface of the clear or mostly clear ophthalmic lens 702. Again, the blue blocking component 703 is posterior to the color-balancing component 704. An AR component 701 may be formed on or adjacent to the posterior surface of the blue blocking component 703. Another AR component 705 may be formed on or adjacent to the anterior surface of the clear or mostly clear ophthalmic lens 702.

In FIG. 7C, the blue blocking component 703 and the color-balancing component 704 are arranged on or adjacent to the posterior and the anterior surfaces, respectively, of the clear ophthalmic lens 702. Again, the blue blocking component 703 is posterior to the color-balancing component 704. An AR component 701 may be formed on or adjacent to the posterior surface of the blue blocking component 703, and another AR component 705 may be formed on or adjacent to the anterior surface of the color-balancing component 704.

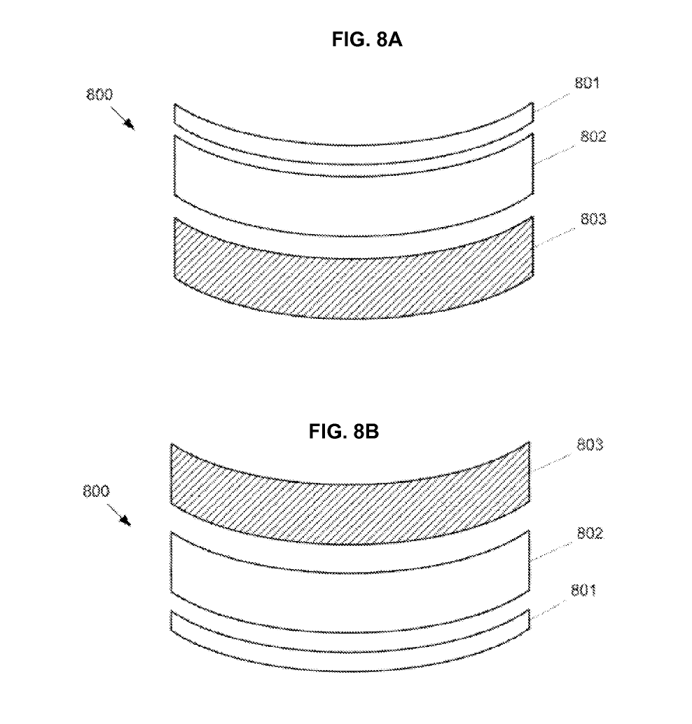

FIGS. 8A and 8B show another embodiment of an ophthalmic system according to the present invention. In the system 800 of FIGS. 8A and 8B, functionality to both block blue light wavelengths and to perform color balancing may be combined in a single component 803. For example, the combined functionality component may block blue light wavelengths and reflect some green and red wavelengths as well, thus neutralizing the blue and eliminating the appearance of a dominant color in the lens. The combined functionality component 803 may be arranged on or adjacent to either the anterior or the posterior surface of a clear ophthalmic lens 802. While the present embodiment concerns only a single blue blocking/color balancing component, it is envisioned that it would first act to provide color balancing and then block blue light, in accordance with the present invention. The ophthalmic lens 800 may further include an AR component 801 on or adjacent to either the anterior or the posterior surface of the clear ophthalmic lens 802.

As discussed previously, filters are one technique for blue blocking. Accordingly, any of the blue blocking components discussed could be or include or be combined with blue blocking filters. Such filters may include rugate filters, interference filters, band-pass filters, band-block filters, notch filters or dichroic filters.

In other embodiments of the invention, one or more of the above-disclosed blue-blocking techniques may be used in conjunction with other blue-blocking techniques. By way of example only, a lens or lens component may utilize both a dye/tint and a rugate notch filter to effectively block blue light.

Any of the above-disclosed structures and techniques may be employed in an ophthalmic system according to the present invention to perform blocking of blue light wavelengths at or near 450 nm. For example, in embodiments the wavelengths of blue light blocked may be within a predetermined range centered at 450 nm. In embodiments, the range may extend from 450 nm±(plus or minus) about 10 nm (i.e., between about 440 nm and about 460 nm). In other embodiments, the range may extend from 450 nm±about 20 nm (i.e., between about 430 nm and about 470 nm). In still other embodiments, the range may extend from 450 nm±about 30 nm (i.e., between about 420 nm and about 480 nm). In still other embodiments, the range may extend from 450 nm±about 40 nm (i.e., between about 410 nm and about 490 nm). In still other embodiments, the range may extend from 450 nm±about 50 nm (i.e., between about 400 nm and about 500 nm). In embodiments, the ophthalmic system may limit transmission of blue wavelengths within the above-defined ranges to substantially 90% of incident wavelengths. In other embodiments, the ophthalmic system may limit transmission of the blue wavelengths within the above-defined ranges to substantially 80% of incident wavelengths. In other embodiments, the ophthalmic system may limit transmission of the blue wavelengths within the above-defined ranges to substantially 70% of incident wavelengths. In other embodiments, the ophthalmic system may limit transmission of the blue wavelengths within the above-defined ranges to substantially 60% of incident wavelengths. In other embodiments, the ophthalmic system may limit transmission of the blue wavelengths within the above-defined ranges to substantially 50% of incident wavelengths. In other embodiments, the ophthalmic system may limit transmission of the blue wavelengths within the above-defined ranges to substantially 40% of incident wavelengths. In still other embodiments, the ophthalmic system may limit transmission of the blue wavelengths within the above-defined ranges to substantially 30% of incident wavelengths. In still other embodiments, the ophthalmic system may limit transmission of the blue wavelengths within the above-defined ranges to substantially 20% of incident wavelengths. In still other embodiments, the ophthalmic system may limit transmission of the blue wavelengths within the above-defined ranges to substantially 10% of incident wavelengths. In still other embodiments, the ophthalmic system may limit transmission of the blue wavelengths within the above-defined ranges to substantially 5% of incident wavelengths. In still other embodiments, the ophthalmic system may limit transmission of the blue wavelengths within the above-defined ranges to substantially 1% of incident wavelengths. In still other embodiments, the ophthalmic system may limit transmission of the blue wavelengths within the above-defined ranges to substantially 0% of incident wavelengths. Stated otherwise, attenuation by the ophthalmic system of the electromagnetic spectrum at wavelengths in the above-specified ranges may be at least 10%; or at least 20%; or at least 30%; or at least 40%; or at least 50%; or at least 60%; or at least 70%; or at least 80%; or at least 90%; or at least 95%; or at least 99%; or substantially 100%.

At the same time as wavelengths of blue light are selectively blocked as described above, at least 85%, and in other embodiments at least 95%, of other portions of the electromagnetic spectrum may be transmitted by the ophthalmic system. Stated otherwise, attenuation by the ophthalmic system of the electromagnetic spectrum at wavelengths outside the blue light spectrum, e.g. wavelengths other than those at or near 450 nm may be 15% or less, and in other embodiments, 5% or less.

Additionally, embodiments of the present invention may further block ultra-violet radiation the UVA and UVB spectral bands as well as infra-red radiation with wavelengths greater than 700 nm.

Any of the above-disclosed ophthalmic system may be incorporated into an article of eyewear, including externally-worn eyewear such as eyeglasses, sunglasses, goggles or contact lenses. In such eyewear, because the blue-blocking component of the systems is posterior to the color balancing component, the blue-blocking component will always be closer to the eye than the color-balancing component when the eyewear is worn. The ophthalmic system may also be used in such articles of manufacture as surgically implantable intra-ocular lenses.

Several embodiments of the invention are specifically illustrated and/or described herein. However, it will be appreciated that modifications and variations of the invention are covered by the above teachings and within the purview of the appended claims without departing from the spirit and intended scope of the invention.

1-21. (canceled)

22. The An ophthalmic system comprising a selective blue-blocking component that attenuates the electromagnetic spectrum for wavelengths from about 440 nm to about 460 nm by at least 10%.

23. The ophthalmic system of claim 22, wherein said system attenuates the electromagnetic spectrum for wavelengths from about 440 nm to about 460 nm by at least 20%.

24. The ophthalmic system of claim 22, wherein said system attenuates the electromagnetic spectrum for wavelengths from about 440 nm to about 460 nm by at least 30%.

25. The ophthalmic system of claim 22, wherein said system attenuates the electromagnetic spectrum for wavelengths from about 440 nm to about 460 nm by at least 40%.

26. The ophthalmic system of claim 22, wherein said system attenuates the electromagnetic spectrum for wavelengths from about 440 nm to about 460 nm by at least 50%.

27. The ophthalmic system of claim 22, wherein said system attenuates the electromagnetic spectrum for wavelengths from about 440 nm to about 460 nm by at least 60%.

28. The ophthalmic system of claim 22, wherein said system attenuates the electromagnetic spectrum for wavelengths from about 440 nm to about 460 nm by at least 70%.

29. The ophthalmic system of claim 22, wherein said system attenuates the electromagnetic spectrum for wavelengths from about 440 nm to about 460 nm by at least 80%.

30. The ophthalmic system of claim 22, wherein said system attenuates the electromagnetic spectrum for wavelengths from about 440 nm to about 460 nm by at least 90%.

31. The ophthalmic system of claim 22, wherein said system attenuates the electromagnetic spectrum for wavelengths from about 440 nm to about 460 nm by at least 95%.

32. The ophthalmic system of claim 22, wherein said system attenuates the electromagnetic spectrum for wavelengths from about 440 nm to about 460 nm by at least 99%.

33. The ophthalmic system of claim 22, wherein said system attenuates the electromagnetic spectrum for wavelengths from about 440 nm to about 460 nm by substantially 100%.

34. The ophthalmic system of claim 22, wherein said system transmits at least 85% of visible wavelengths outside the range of about 440 nm to about 460 nm.

35. The ophthalmic system of claim 34, wherein said system transmits at least 95% of visible wavelengths outside the range of about 440 nm to about 460 nm.

36. The ophthalmic system of claim 22, wherein the system also attenuates UVA, UVB, and/or infrared radiation.

37. (canceled)

38. The ophthalmic system of claim 22, further comprising an anti-reflective component.

39-51. (canceled)

52. The ophthalmic system of claim 22, further comprising a color-balancing component.
